(19) United States
(12) Patent Application Publication
(10) Pub. No.: US 2006/0123109 A1
(43) Pub. Date: Jun. 8, 2006

(54) Method for processing HTTP requests and HTML pages transmitted or received by a navigator to or from at least one web server, and associated server

(76) Inventors: Jerome Laforge, Troarn (FR); Jean-Pierre Deschrevel, Putot En Bessin (FR); Denis Gautier, Ouistreham (FR)

Correspondence Address: YOUNG & THOMPSON, 745 SOUTH 23RD STREET, 2ND FLOOR, ARLINGTON, VA, 22202, US

(21) Appl. No.: 11/295,524

(22) Filed: Dec. 7, 2005

(30) Foreign Application Priority Data
Dec. 8, 2004 (FR) 0413088

(51) Int. Cl. G06F 15/173

(52) U.S. Cl. 709/224

(57) ABSTRACT

The invention relates to a method for processing HTTP requests and HTML pages transmitted or received by a navigator to or from at least one Web server such that all of the data-flows between the navigator and each Web server pass via an interposition server (P), comprising the steps of: storing (2) a list of configuration parameters defining data to be selected from the data-flows between the navigator and each Web server; acquiring (4) data to be selected by filtering the HTTP requests and HTML pages passing via the interposition server; selecting (4) forms contained in the data-flows and containing at least one entry field corresponding to at least one configuration parameter, and modifying (6) the or each entry field found by adding a default value corresponding to one of the previously acquired data.

### TECHNICAL FIELD

The present invention relates to a method for processing HTTP requests and HTML pages transmitted or received by a navigator to or from at least one Web server such that all of the data-flows between the navigator and each Web server pass via an interposition server.

### BACKGROUND TO THE INVENTION

The person skilled in the art is familiar with the use of a form (HTML <form> tag) to enable a user to enter data which will be transferred to the server (http GET and POST request) for a particular processing operation.

In the presence of those forms, some navigators recognize that an identical form has already been filled out previously by the user and therefore propose to the user a history of the former entries in the form of a menu (for example, Internet Explorer of the company Microsoft Inc.). However, this is carried out locally and is limited to multiple use of the same form.

In addition, it is known to use on a personal computer a temporary storage zone, often called a “clipboard”, to transfer data between two applications in accordance with the technique called “cut and paste”.

However, none of those techniques can be used to recover data from a first Web server to complete a form originating from a second Web server, another HTML application, or even quite simply another HTML page.

The object of the invention is to overcome that disadvantage by enabling an HTML form to be filled out using data originating from other HTTP requests or other HTML pages.

### SUMMARY OF THE INVENTION

The invention therefore relates to a method for processing HTTP requests and HTML pages transmitted or received by a navigator to or from at least one Web server such that all of the data-flows between the navigator and each Web server pass via an interposition server, characterized in that it comprises the steps of:

storing a list of configuration parameters defining data to be selected from the data-flows between the navigator and each Web server;

acquiring data to be selected by filtering the HTTP requests and HTML pages passing via the interposition server;

selecting forms contained in the data-flows and containing at least one entry field corresponding to at least one configuration parameter, and

modifying the or each entry field found by adding a default value corresponding to one of the previously acquired data.

According to particular embodiments, the method comprises one or more of the following features:

each of the configuration parameters comprises an identification key, the address of the corresponding page or request and parameters for selecting data within that page or request;

the data selection parameters comprise regular expressions; and

the entry field modified by the addition of a default value also comprises an attribute for modifying its appearance.

The invention relates also to an interposition server for HTTP requests and HTML pages transmitted or received by at least one navigator to or from a plurality of Web servers such that all of the data-flows between the navigator and the Web servers pass via the interposition server, comprising first means for storing a list of configuration parameters defining data to be selected from the data-flows, which means are connected to means for analyzing requests and pages from the data-flows suitable for selecting and storing data from those requests and pages as a function of the configuration parameters in second storage means, the analysis means and the second storage means being connected to means for modifying at least one entry field of an HTML form passing via this server by the addition of a default value corresponding to one of the previously selected and stored data.

According to particular embodiments of the server:

each of the configuration parameters stored in the first storage means comprises an identification key, the address of the corresponding page or request and parameters for selecting data within that page or request;

the data selection parameters comprise regular expressions; and

it also comprises means for modifying the appearance of the entry field modified by the addition of a default value.

The invention relates also to a memory medium comprising program instructions suitable for implementing the method for processing HTTP requests and HTML pages when that program is executed in the interposition server.

### BRIEF DESCRIPTION OF DRAWINGS

The invention will be better understood on reading the following description which is given purely by way of example and with reference to the appended drawings in which:

FIG. 1 is a block diagram of a system according to a preferred embodiment of the invention;

FIG. 2 is a diagram of the data-flows in a preferred embodiment of the invention.

### DESCRIPTION OF PREFERRED EMBODIMENT

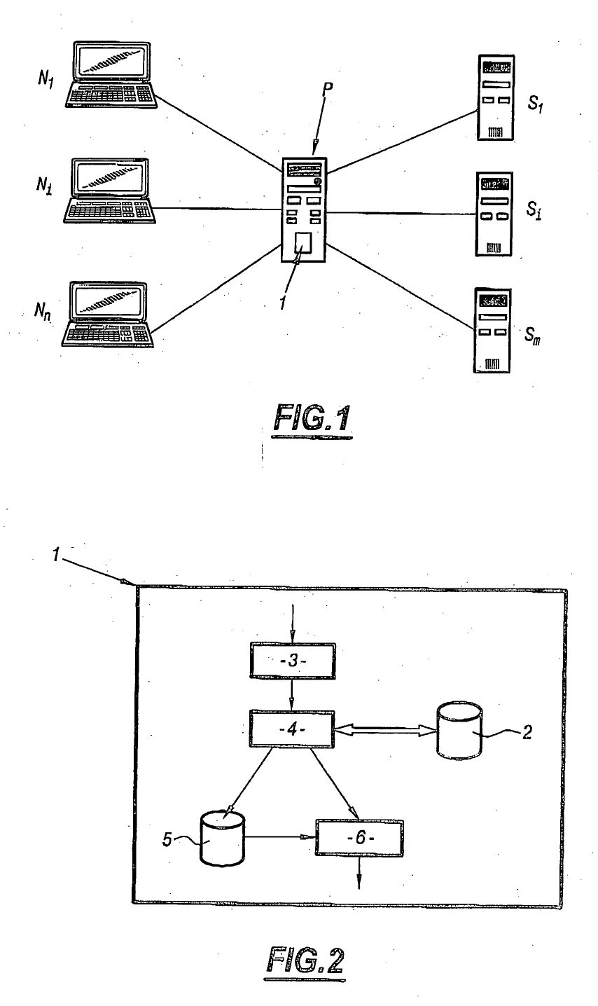

With reference to FIG. 1, workstations having an Internet navigator N₁, . . . , Nᵢ, . . . Nₙ are connected by the Internet network through an interposition server P to Web servers S₁, . . . , Sᵢ, . . . , Sₘ which may or may not belong to different domains.

The structure and general operation of such an interposition server are described in the literature under the name of proxy server. It is possible for the interposition server P to maintain a session peculiar thereto. It may, for example, be an ICAP server with a cookie, or an interposition server with a state memory, such as described in WO01/11821. For the purposes of the following description, it is necessary to remember only that all of the data-flows between the navigators N₁ . . . , Nᵢ . . . , Nₙ and the Web servers S₁ . . . , Sᵢ . . . , Sₘ pass via the interposition server P.

The latter also comprises a plug-in 1 capable of analyzing and modifying all of the flows of HTML pages passing via the interposition server P.

We understand HTML (HyperText Markup Language) to mean any standard for describing the organization of a hypertext page, such as, for example, the DHTML (Dynamic HyperText Markup Language) or the XML (Extensible Markup Language).

As shown in FIG. 2, the plug-in 1 comprises means 2 for storing configuration parameters, and means 3 for acquiring an HTTP request or an HTML page, which means are connected to means 4 for analyzing the page as a function of the configuration parameters stored in the storage means 2. The analysis means 4 are connected to second storage means 5 for recording the value of the parameters found during analysis and to means 6 for modifying the HTML page, which are themselves connected to transmission means of the interposition server in order to enable that HTML page to be sent to its recipient.

The operation of the plug-in 1 will now be described.

Before any execution, the configuration parameters are stored manually in the interposition server P in the generic form of a name called an “identification key” and criteria for initializing it, as will be explained hereinafter. The identification key is an identifier for making the link between an initialization step and a use step.

The initialization step is carried out in accordance with two operating modes.

In a first operating mode, it is assumed that the intercepted flow in fact corresponds to a request originating from a navigator. That request is then characterized by a URL (<<Uniform Resource Locator>>) address which may or may not be accompanied by a series of parameters. Those parameters are transmitted, in an http request, by a GET or POST method and in accordance with the syntax, for each parameter,
Name_of_parameter=value_of_parameter

For each parameter whose value it is desired to store, the plug-in 1 has as configuration parameters a triplet (identification key, URL, Name_of_parameter). The analysis means 4 then conduct a search to establish whether, for a given URL, there are triplets corresponding to the parameters transferred in the request (same parameter name) and then store in the storage means 5 the identification key linked to the value of the parameter.

In a second operating mode, the intercepted flow corresponds to an HTML page transmitted by a Web server, for example, in response to the request of the previous navigator.

For that type of page, the configuration parameters of the plug-in 1 comprise the URL of the page, a regular expression containing one or more groups, one or more group numbers and one or more identification keys.

Since the technology of “regular expressions” is well known to the person skilled in the art, the details of its operation and its implementation can easily be found in the literature, such as, for example, “Mastering regular expressions”, Jeffrey E. F. Friedl, O'Reilly, 2^{nd} edition, June 2003. It is necessary to remember here only that a regular expression is a method of recognizing a chain of characters having given characteristics.

The analysis means 4 therefore use regular expressions to detect, in the page having a given URL, data fields which will then be stored in the means 5 with the corresponding identification key(s).

The above two operating modes therefore enable the storage means 5 to be stocked with a set of identification keys associated with data. This thus corresponds to a method of collecting data.

Since those two operating modes do not modify the request/page concerned, the latter can be sent to its recipient in parallel with the processing described above.

The data thus collected to fill out HTML forms, passing via the interposition server P, are then used in the use step.

As is well known to the person skilled in the art, an HTML file containing a form comprises a set of data held between two HTML tags <form> and </form>. Attributes of that <form> tag indicate, among other things, the URL of the HTML page to be called up when the form is output as well as the HTTP GET or POST method to be used to pass the parameters.

Inside those tags <form> </form>, in addition to text and formatting tags, there is at least one <input> tag defining a data entry zone. One of the attributes, called “type”, of that tag defines the type of entry field (text zone, menu, radio button, . . . ). A “name” attribute defines the name of the tag and another attribute, called “value”, defines the default value of the tag.

It should be noted that, with some navigators, the <form> and </form> tags are optional.

The configuration parameters of the plug-in 1 therefore contain an identification key for a given HTML page, defined by its URL, and a given form field, defined by its name.

Thus, when the interposition server P intercepts the HTML page containing the form, the analysis means 4 conduct a search for the corresponding entry field, and then for the associated identification key. The analysis means 4 then conduct a search in the storage means 5 for the value associated with that identification key during the first and second operating modes.

That associated value is then transmitted to the means 6 for modifying the HTML page. Those means then complete the “value” attribute of the <input> tag with that value.

They also modify the appearance of the zone, for example, by modifying the corresponding class in the CSS style sheet (Cascading Style Sheet).

That page so modified is then transferred to the other means of the interposition server P in order to be sent to the user.

Thus, a page comprising

. . .

<input name=“Address” type=“text” size=“40”>

. . .

becomes

. . .

<input name=“Address” type=“text” value=“2 rue de Rivoli, Paris” class=“.Modifies” size=“40”>

. . .

Just as the plug-in 1 is capable of modifying the contents of an <input> tag, it can also modify other types of form field, such as, for example, the <select> tag, corresponding to a list of options, from which it selects the correct option <option>.

It is noteworthy that the plug-in 1 is capable of carrying out some simple processing operations on the data recorded in the storage means 5. It can, for example, cut the data in accordance with a regular expression, merge data or transform them (for example “YES” into “OUI”, “NO” into “NON”, . . . )

Thus, in a remarkable manner, it is possible to recover data originating from a Web page or from an HTTP request in order to complete an HTML form belonging to another Web page.

1. Method for processing HTTP requests and HTML pages transmitted or received by a navigator to or from at least one Web server such that all of the data-flows between the navigator and each Web server pass via an interposition server, wherein the method comprises the steps of:
storing a list of configuration parameters defining data to be selected from the data-flows between the navigator and each Web server;
acquiring data to be selected by filtering the HTTP requests and HTML pages passing via the interposition server;
selecting forms contained in the data-flows and containing at least one entry field corresponding to at least one configuration parameter, and
modifying the or each entry field found by adding a default value corresponding to one of the previously acquired data.

2. Method for processing HTTP requests and HTML pages according to claim 1, wherein each of the configuration parameters comprises an identification key, the address of the corresponding page or request and parameters for selecting data within that page or request.

3. Method for processing HTTP requests and HTML pages according to claim 2, wherein the data selection parameters comprise regular expressions.

4. Method for processing HTTP requests and HTML pages according to claim 1, wherein the entry field modified by the addition of a default value also comprises an attribute for modifying its appearance.

5. Method for processing HTTP requests and HTML pages according to claim 2, wherein the entry field modified by the addition of a default value also comprises an attribute for modifying its appearance.

6. Method for processing HTTP requests and HTML pages according to claim 3, wherein the entry field modified by the addition of a default value also comprises an attribute for modifying its appearance.

7. Interposition server for HTTP requests and HTML pages transmitted or received by at least one navigator to or from a plurality of Web servers such that all of the data-flows between the navigator and the Web servers pass via the interposition server, wherein said interposition server comprises first means for storing a list of configuration parameters defining data to be selected from the data-flows, which means are connected to means for analyzing HTTP requests and pages from the data-flows suitable for selecting and storing data from those requests and pages as a function of the configuration parameters in second storage means, the analysis means and the second storage means being connected to means for modifying at least one entry field of an HTML form passing via this server by the addition of a default value corresponding to one of the previously selected and stored data.

8. Interposition server for HTTP requests and HTML pages according to claim 7, wherein each of the configuration parameters stored in the first storage means comprises an identification key, the address of the corresponding page or request and parameters for selecting data within that page or request.

9. Interposition server for HTTP requests and HTML pages according to claim 8, wherein the data selection parameters comprise regular expressions.

10. Interposition server for HTTP requests and HTML pages according to claim 8, and further comprising means for modifying the appearance of the entry field modified by the addition of a default value.

11. Memory medium comprising program instructions suitable for implementing a method for processing HTTP requests and HTML pages transmitted or received by a navigator to or from at least one Web server such that all of the data-flows between the navigator and each Web server pass via an interposition server, wherein the method comprises the steps of:
storing a list of configuration parameters defining data to be selected from the data-flows between the navigator and each Web server;
acquiring data to be selected by filtering the HTTP requests and HTML pages passing via the interposition server;
selecting forms contained in the data-flows and containing at least one entry field corresponding to at least one configuration parameter, and
modifying the or each entry field found by adding a default value corresponding to one of the previously acquired data and wherein the program is executed in an interposition server.

12. Memory medium according to claim 11, wherein each of the configuration parameters comprises an identification key, the address of the corresponding page or request and parameters for selecting data within that page or request.

13. Memory medium according to claim 12, wherein the data selection parameters comprise regular expressions.

14. Memory medium according to claim 11, wherein the entry field modified by the addition of a default value also comprises an attribute for modifying its appearance.

15. Memory medium according to claim 11, wherein said interposition server comprises first means for storing a list of configuration parameters defining data to be selected from the data-flows, which means are connected to means for analyzing HTTP requests and pages from the data-flows suitable for selecting and storing data from those requests and pages as a function of the configuration parameters in second storage means, the analysis means and the second storage means being connected to means for modifying at least one entry field of an HTML form passing via this server by the addition of a default value corresponding to one of the previously selected and stored data.

16. Memory medium according to claim 15, wherein each of the configuration parameters stored in the first storage means comprises an identification key, the address of the corresponding page or request and parameters for selecting data within that page or request.

17. Memory medium according to claim 16, wherein the data selection parameters comprise regular expressions.

18. Memory medium according to claim 16 and further comprising means for modifying the appearance of the entry field modified by the addition of a default value.
